(19) United States
(12) Patent Application Publication
(10) Pub. No.: US 2009/0303328 A1
(43) Pub. Date: Dec. 10, 2009

(54) SURVEILLANCE SYSTEM AND CONTROL APPARATUS THEREFOR

(75) Inventors: Takashi Miyawaki, Saga-ken (JP); Youji Yasuda, Saga-ken (JP); Kouichi Tsubokura, Saga-ken (JP); Yuuji Wasai, Saga-ken (JP)

Correspondence Address: DUANE MORRIS LLP - Philadelphia;IP DEPARTMENT, 30 SOUTH 17TH STREET, PHILADELPHIA, PA, 19103-4196, US

(73) Assignee: TOA CORPORATION, Kobe-shi, Hyogo-ken (JP)

(21) Appl. No.: 12/065,875

(22) PCT Filed: Sep. 5, 2006
(86) PCT No.: PCT/JP2006/317537

§ 371 Date: Apr. 14, 2009

(30) Foreign Application Priority Data
Sep. 9, 2005 (JP) 2005-261758

(51) Int. Cl. H04N 7/18

(52) U.S. Cl. 348/159; 348/E07.085

(57) ABSTRACT

[Object] To provide a surveillance system having a wide range of applicability.

[Realizing Means] A surveillance system 10 includes a plurality of recorders 20, 20, . . . . The recorders 20, 20, . . . , are grouped for each floor of a building. Each group of recorders 20, 20, . . . , is connected in series to a monitor device 80, 82 or 84. A plurality of surveillance cameras 50, 50, . . . , are connected to the recorders 20, 20, . . . . The recorders 20, 20, . . . , are connected to a single controller 60. The controller 60 controls each group of recorders 20, 20, . . . .

### TECHNICAL FIELD

This invention relates to a surveillance system and a control apparatus therefor, such as a surveillance system including one or more video devices coupled in series to a display device, and a control apparatus for such surveillance system.

### TECHNICAL BACKGROUND

An example of prior art surveillance systems of this type is disclosed in Non-Patent Literature 1. According to this prior art, a digital disc recorder acting as a master video device is disposed in, for example, a security room on a first floor of a building. A slave digital disc recorder is disposed on each of second through fourth floors of the building. The master and slave digital disc recorders are connected in series to a monitor device disposed in the security room and also connected to a system controller also disposed in the security room, via other, control lines. A maximum of sixteen cameras are connected to each digital disc recorder. When the system controller is operated to monitor an image taken by any one of the cameras, the image taken by that camera is displayed on the monitor device. In other words, according to this prior art, the entire digital disc recorders forming the surveillance system can be controlled as if they were a single recorder.

[Non-Patent Literature 1] Catalog of Digital Disc Recorders “WJ-HD350 Series” manufactured by Matsushita Electric Industrial Co., Ltd., Catalog No. 2005-05-010-T1 Page 9.

### DISCLOSURE OF THE INVENTION

### Problem to be Solved by the Invention

According to the above-described prior art, however, since all of the digital disc recorders are controlled as if they were a single recorder, it is difficult to perform some surveillance operations. For example, simultaneous monitoring of images taken by cameras on different floors is not possible. In other words, the applicability as a surveillance system is narrow. An object of the present invention is to provide a surveillance system having wide applicability and a control apparatus for such surveillance system.

### Means to Solve the Problem

A surveillance system according to the present invention includes a plural groups each including a display device and one or more video devices connected in series to the display device, and a control apparatus controlling each video device. One or more cameras are connected to each video device. Each video device may be switchable so that it can output an image from a camera or an image recorded in built-in recording means, or can output an image provided by another video device. When a first command is provided for causing a processed image from a desired one of the video devices, including an image taken by a camera of the desired video device, to be displayed on a display device, the control apparatus controls all of the video devices in the group to which the desired video device belongs, in accordance with the first command. For example, when the first command is provided, the control apparatus may control the desired video device so as to output the processed image and control all of the video devices between the desired video device and the display device so as to output an image supplied from another video device.

Thus, an image processed by any desired video device in any group to which the first command is provided is displayed on the display device of that group. In other words, the control apparatus controls the video devices group by group.

The control apparatus may include memory means with information stored therein indicating which video devices are assigned to respective groups, and control performing means for performing control according to the first command in accordance with the information stored in the memory means when the first command is provided.

For the video devices with individual identification codes attached thereto and the groups with individual group codes attached thereto, the correlation between each group and video devices may be specified by means of the identification and group codes. For example, the identification code for each video device may be such as to distinguish that video device from the other video devices in the same group. If a plurality of cameras are connected to each video device, an identification code can be assigned to each camera in each group. In such case, each camera and the video device to which that camera is connected are correlated with each other and the correlation is stored in the memory means, whereby the video device to which a specified camera is connected can be designated by specifying the group identification code of the group in which the specified camera is included and the identification code of that camera.

Further, each video device may be so arranged that a sequence of operation procedures may be preset therein. In such case, the control apparatus, when provided with a second command for a desired one of the groups, causes all of the video devices in that group to sequentially perform the operations in accordance with the sequence of operation procedures preset therein. In this manner, sequences of operations of all of the video devices in each group can be successively performed.

### BRIEF DESCRIPTION OF THE DRAWINGS

FIG. 1 shows an entire schematic arrangement of a surveillance system according to one embodiment of the present invention.

FIG. 2 is a block diagram of a controller of the surveillance system of FIG. 1.

FIG. 3 is a schematic representation of contents of a grouping table stored in a memory circuit in the controller of FIG. 2.

FIG. 4 is a block diagram of a recorder in the surveillance system of FIG. 1.

FIG. 5 is a flow chart showing contents of a recorder selecting task performed by the controller of FIG. 2.

FIG. 6 is a flow chart showing contents of a video selecting task performed by the recorder of FIG. 4.

FIG. 7 is useful in explaining sequential operations of the recorder of FIG. 4.

FIG. 8 is useful in explaining a group sequence operation of the surveillance system of FIG. 1.

FIG. 9 is a diagram illustrating information exchanges between the controller and the recorders done in the group sequence operation shown in FIG. 8.

FIG. 10 is a flow chart showing contents of a group sequence task performed by the controller of FIG. 2.

FIG. 11 is a flow chart showing contents of an intra-group sequence task performed by the recorder of FIG. 4.

FIG. 12 shows an entire schematic arrangement of a surveillance system according to another embodiment of the present invention.

FIG. 13 shows an entire schematic arrangement of a surveillance system according to a different embodiment of the present invention.

### BEST STATE FOR CARRYING OUT THE INVENTION

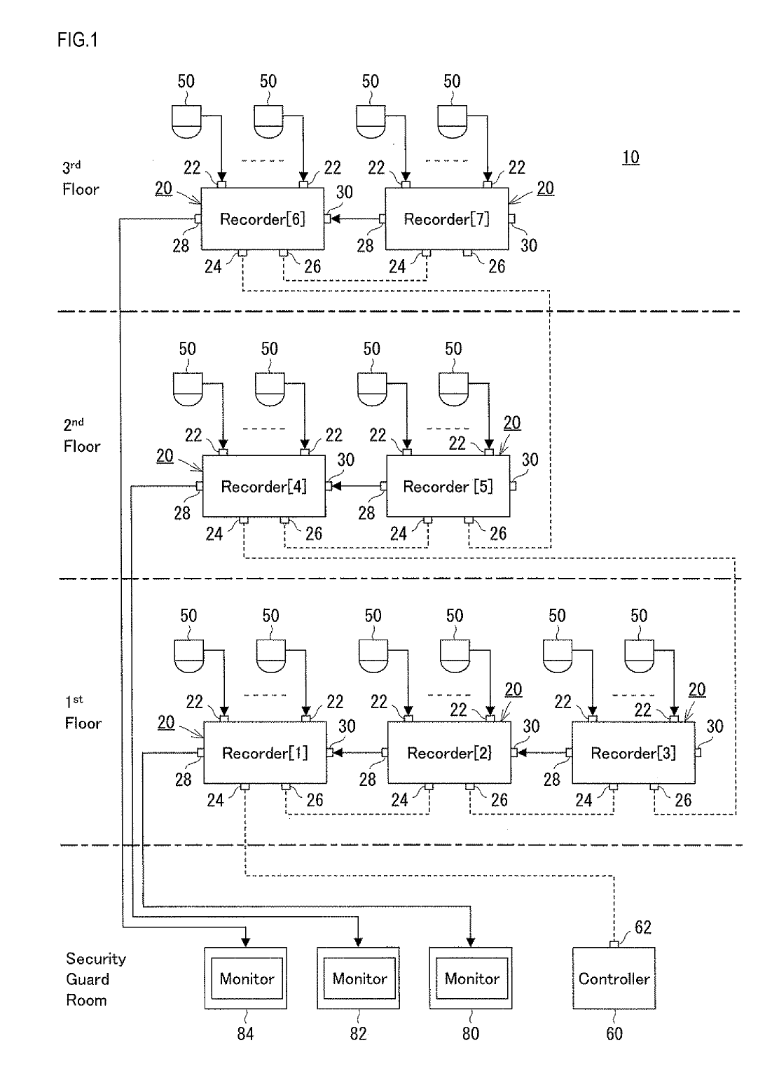

Embodiments of the present invention are described with reference to FIGS. 1 through 13.

A surveillance system 10 according to an embodiment of the invention may be carried out for a three-storied building, for example, as shown in FIG. 1. The surveillance system 10 includes a plurality, seven in total, in the illustrated example, of video devices. The video devices may be, for example, digital recorders (hereinafter referred to simply as recorders) 20, 20, . . . . Such recorders 20, 20, . . . , are installed on respective floors. For example, three of the recorders 20, 20, . . . , are on the first floor, two are on the second floor, and two are on the third floor.

Not greater than sixteen (16) surveillance cameras 50, 50, . . . , can be connected to each recorder 20. For that purpose, each recorder 20 is provided with sixteen (16) camera connection terminals 22, 22, . . . . The respective surveillance cameras 50, 50, . . . , are installed at appropriate locations on the same floor as the recorder 20 to which the surveillance cameras 50, 50, . . . , are connected. Video signals developed by the surveillance cameras 50, 50, . . . , are recorded in the recorders 20, as will be described later. The surveillance cameras 50 may be of a combination type of which field-of-view direction and angle of view can be changed as desired, or may be of a fixed type of which field of view is fixed.

The recorders 20, 20, . . . , are given individual recorder real numbers [n] as identification codes. For example, serial numbers [1] through [7] are respectively assigned to the recorders consecutively from the ones on the first floor to the ones on the third floor. As indicated by broken lines shown in FIG. 1, the respective recorders 20, 20, . . . , are connected to a controller 60 installed in a security guard room by control lines complying with RS-485 Standard. For this connection, each recorder 20 has a control input terminal 24 and a control output terminal 26. The control input terminal 24 of the recorder 20 having a recorder real number [1] as the recorder real number [n] is connected to a control terminal 62 of the controller 60. (Hereinafter, when any particular recorder 20 is specified, it is designated by means of the recorder real number [n], like the recorder [1].) The control output terminal 26 of the recorder [1] is connected to the control input terminal 24 of the recorder [2]. The succeeding recorders 20, 20, . . . , are serially connected in the same manner. In FIG. 1, the recorders 20, 20, . . . , are shown being connected in series to the controller 60 through the control lines, but, since the control lines are in compliance with RS-485 Standard, as described above, the recorders 20, 20, . . . , are bus-connected to the controller 60 in an electrical sense. Data transfer between the controller 60 and the respective recorders 20, 20, . . . , through the control line are performed in the known polling method. Each recorder 20 has one image output terminal 28 and one image input terminal 30. The recorders 20, 20, . . . , disposed on the same floor are connected in series, through the respective image output terminals 28 and image input terminals 30, to a corresponding monitor device, operating as a display device, 80, 82 or 84, in the order of their lowness of recorder real number [n], a recorder with the lowest recorder real number [n] first.

For example, with respect to the three recorders [1], [2] and [3] on the first floor, the image output terminal 28 of the recorder [1] is connected to the monitor device 80. The image input terminal 30 of the recorder [1] is connected to the image output terminal 28 of the recorder [2] having its image input terminal 30 connected to the image output terminal 28 of the recorder [3]. The image input terminal 30 of the recorder [3] is open. As for the two recorders [4] and [5] on the second floor, the image output terminal 28 of the recorder [4] is connected to the monitor device 82, and the image input terminal 30 of the recorder [4] is connected to the image output terminal 28 of the recorder [5] having its image input terminal 30 opened. Similar to those on the second floor, the recorders [6] and [7] are connected in such a manner that the image output terminal 28 of the recorder [6] is connected to the monitor device 84, the image input terminal 30 of the recorder [6] is connected to the image output terminal 28 of the recorder [7], and the image input terminal 30 of the recorder [7] is open. The monitor devices 80, 82 and 84 are disposed in the security guard room together with the controller 60.

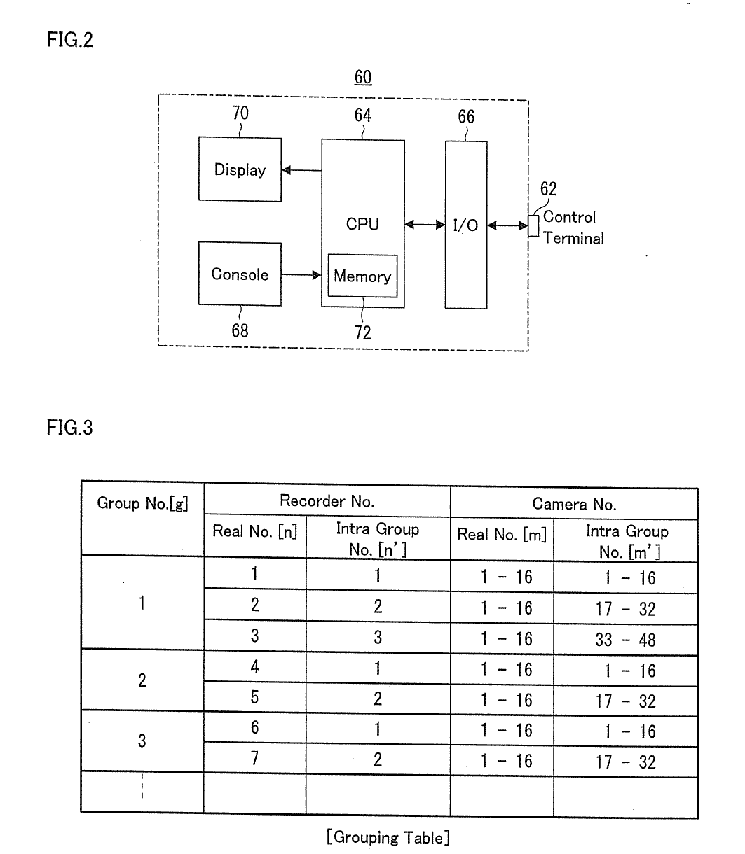

As shown in FIG. 2, the controller 60 includes a CPU 64. The CPU 64 is connected through an input/output interface (I/O) circuit 66 to the control terminal 62. A console unit 68, operating as control means, with input keys, buttons etc., and a display unit 70, operating as display means, including a liquid crystal panel, light-emitting diodes etc. are connected to the CPU 64. Further, the CPU 64 includes a built-in memory circuit 72, operating as memory means, in which a controller control program for controlling the operation of the CPU 64 is stored. A grouping table shown in FIG. 3 is also stored in the memory circuit 72.

The grouping table is a table showing on which floor the respective recorders 20, 20, . . . , are disposed. In the illustrated example, a group is formed for each floor, and the grouping table supervises the recorders 20, 20, . . . , as to which recorders 20, 20, . . . , should belong to each group. An individual group number [g] is assigned to each group. According to the grouping table shown in FIG. 3, the recorders [1], [2] and [3] on the first floor are assigned to the group having a group number [1] as its group number [g]. (Hereinafter, a particular group is referred to by its real number, as the group [1].) These recorders [1], [2] and [3] are given numbers [1], [2] and [3] valid within the group [1] as their respective “intra-group” recorder numbers [n′]. As described above, each recorder 20 is provided with sixteen (16) camera connection terminals 22, 22, . . . , and these camera connection terminals 22, 22, . . . , are also given individual camera real numbers [1] through [16] as their camera real numbers [m] valid in each of the recorders 20, 20 . . . . All of these camera connection terminals 22, 22, . . . , are also given numbers [1] through [48] as their respective intra-group camera numbers [m′] valid within the group [1]. For example, the camera connection terminals 22, 22, . . . , of the recorder 20 having an intra-group recorder number [1] are given intra-group camera numbers [1] through [16], the camera connection terminals 22, 22, . . . , of the recorder 20 having an intra-group recorder number [2] are given intra-group camera numbers [17] through [32], and the camera connection terminals 22, 22, . . . , of the recorder 20 having an intra-group recorder number [3] are given intra-group camera numbers [33] through [48].

The recorders [4] and [5] are assigned to the group [2]. The recorders [4] and [5] are also given intra-group recorder numbers [1] and [2], respectively, as recorder numbers [n′] valid within the group [2]. The camera connection terminals 22, 22, . . . , of the recorders [4] and [5] are given intra-group camera numbers [1]-[32], respectively, in the successive order, as camera numbers [m′] valid within the group [2]. For example, the camera connection terminals 22, 22, . . . , of the recorder 20 having an intra-group recorder number [2] are given the intra-group camera numbers [1] through [16] successively, and the camera connection terminals 22, 22, . . . , of the recorder 20 having an intra-group recorder number [2] are given the intra-group camera numbers [17] through [32] in the successive order.

The recorders [6] and [7] are assigned to the group [3]. The recorders [6] and [7] are also given intra-group numbers [1] and [2], as their intra-group recorder numbers [n′], and all of the camera connection terminals 22, 22, . . . , of the successive ones of the recorders [6] and [7] are given intra-group camera numbers [1] through [32], respectively, as the intra-group camera numbers [m′]. For example, the camera connection terminals 22, 22, . . . , of the recorder 20 having an intra-group recorder number [2] are given the intra-group camera numbers [1] through [16] successively, and the camera connection terminals 22, 22, . . . , of the recorder 20 having an intra-group recorder number [2] are given the intra-group camera numbers [17] through [32] in the successive order.

The grouping table is arranged such that any recorder 20 with a connection terminal 22 having a specified intra-group camera number can be specified by specifying a group number [g] and an intra-group camera number [m′]. The contents of this grouping table are prepared and edited through the operation of the controller 60.

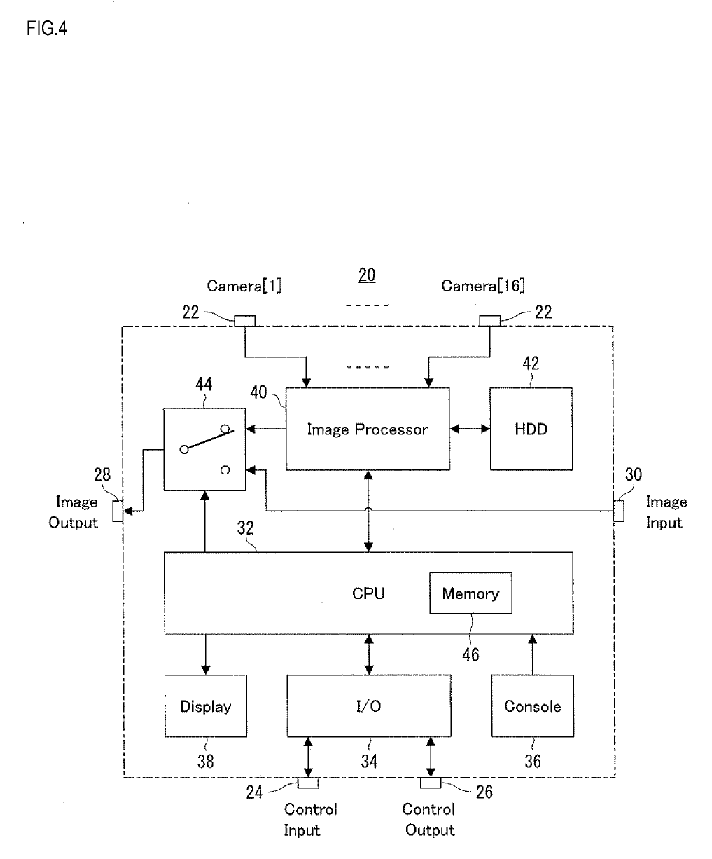

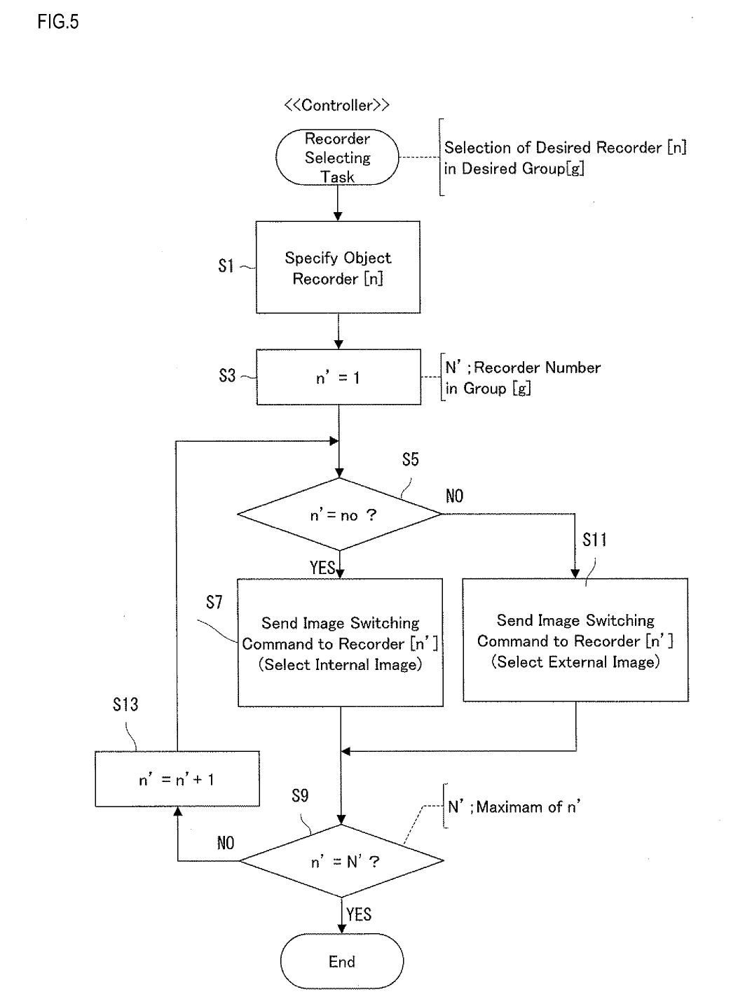

Each recorder 20, too, has a CPU 32 as shown in FIG. 4. The CPU 32 is connected to the control input terminal 24 and the control output terminal 26 via an input/output interface circuit 34. Connected to the CPU 32 are a console unit 36 serving as operating means including input keys, buttons etc., and a display unit 38 serving as display means including a liquid crystal panel, light-emitting diodes etc.

Each recorder 20 includes an image processing circuit 40 as image processing means. The image processing circuit 40 is responsive to a processing command given by the CPU 32 by recording an image taken by surveillance cameras 50, 50, . . . , in a hard disc (HD) 42 serving as record means, or inputting the image to an image switching circuit 44 serving as switching means as will be described later. In the recorder 20 of the illustrated example, the images taken by all of the surveillance cameras 50, 50, . . . , connected to the camera connection terminals 22, 22, . . . , are recorded in the respective hard discs 42 whenever necessary. The intervals at which the images taken are recorded in the hard disc 42 can be set to a desired value for each surveillance camera 50.

The image switching circuit 44 selects, in accordance with a switching command given by the CPU 32, either an internal image, which is an image inputted from the above-described image switching circuit 44 or an external image, which is an image inputted through the image input terminal 30 from other recorder 20 connected to the image input terminal 30. The image selected by the image switching circuit 44 is outputted through the image output terminal 28. The operations of the CPU 32 are controlled in accordance with a recorder control program stored in a memory circuit 46 built in the CPU 32.

With the above-described arrangement of the surveillance system 10, when, for example, a first command, e.g. an operation command for monitoring an image taken by a desired surveillance camera 50 (the image being referred to as live image hereinafter), is generated through operation of the console unit 36 of the controller 60, the CPU 64 of the controller 60 operates in the following manner. It is to be noted that the designation of the surveillance camera 50 is done according to the combination of the group number [g] with the intra-group camera number [m′].

When the desired surveillance camera 50 is designated, the controller 60 first refers to the above-described grouping table. Then, the controller 60 determines, in the grouping table, the intra-group recorder number [n′] of the recorder 20 to which the designated surveillance camera 50 is connected, from the specified group number [g] and intra-group camera number [m′]. The specified recorder is an object recorder [no]. Further, the controller 60 performs such control, for the object recorder [no], that the image processing circuit 40 inputs the live image taken by the designated surveillance camera 50 to the image switching circuit 44 so that the live image taken by the designated surveillance camera 50 can be outputted through the image output terminal 28, and that the image switching circuit 44 selects the live image inputted from the image processing circuit 40. Also, the controller 60 performs such control, for other recorders [n′] in the group [g] to which the object recorder [no] belongs, that the image switching circuit 44 selects an external image. It should be noted that no control is done on the other groups [g].

Assume, for example, that the camera having an intra-group number [18] in the group [2] is designated. The control 60 performs such control that the image switching circuit 44 in the recorder having the intra-group recorder number [2] in the group [2], i.e. the recorder [5], selects the internal image, and that the live image taken by the camera having the intra-group camera number [18] is outputted through the image switching circuit 44 from the image output terminal 28. The controller 60 also provides such control that, in the recorder having the intra-group number [1] in the group [2], i.e. the recorder [4], the image switching circuit 44 selects the external image. No control is provided on the other groups [1] and [3]. As a result, the live image taken by the surveillance camera 50 having the intra-group camera number [18] in the group [2] is displayed on the monitor device 82 for the group [2].

Similar control is achieved when the live image taken by any other surveillance camera 50 is to be monitored. Similar processing is done when the live image taken any one of the surveillance cameras 50 in the other groups [1] and [3] is to be monitored. Further, a plurality of live images taken by surveillance cameras 50, if they are connected to the same recorder 20, can be simultaneously monitored in a multi-picture display, e.g. on a screen split into two, split into four, split into eight, etc. Needless to say, a recorded image can be displayed in a multi-picture display.

As described above, since the surveillance system 10 according to this embodiment have a plurality of video devices 20, 20, . . . , grouped for each floor, the video devices 20, 20, . . . , can be controlled separately for respective groups [g]. In other words, the video devices 20, 20, . . . , in each group [g] can be handled as if they were a single device. Thus, in comparison with the previously described prior art according to which all of digital disc recorders forming a surveillance system are controlled together, the surveillance system 10 has improved applicability so that it can adapt itself to various circumstances. Furthermore, since designation of the camera 50 for display can be made by specifying the group to which that camera belongs and the intra-group camera number in that group, it is not necessary for a user to know to which recorder in a group that camera is connected, and therefore designation of a particular camera can be done easily.

When the controller 60 is operated to monitor a live image or recorded image taken by a desired surveillance camera 50, as described above, the CPU 64 in the controller 60 executes a recorder selecting task represented by the flow chart in FIG. 5 in accordance with the above-mentioned controller control program. The recorder selecting task shown in FIG. 5 is for controlling the switching operation of the image switching circuit 44 in each of the recorders 20, 20, . . . . The operation of the image processing circuit 40 in each of the recorders 20, 20, . . . , is controlled by a separate image processing task. However, detailed description of the image processing task is not made herein since it does not pertain to the subject of the invention.

Reference is now made to FIG. 5. When an operation is effected for monitoring a live image or recorded image taken by a desired surveillance camera 50, the CPU 64 in the controller 60 proceeds to Step S1 to specify, using the specified group number [g] and the intra-group camera number [m′], the intra-group number [n′] of the recorder 20 to which the desired surveillance camera 50 having the intra-group camera number [m′] is connected, and designates that recorder as an object recorder [no]. Then, the CPU 64 proceeds to Step S3 to cause the index of the intra-group number [n′] for designating the recorder 20 in the succeeding processing to become “1”. (The index is also represented by “[n′]”.) After that, the CPU 64 proceeds to Step S5.

In Step S5, the CPU 64 judges whether the currently specified recorder [n′] is the object recorder [no] or not. If the recorder [n′] is the object recorder [no], the CPU 64 sends, in Step S7, the recorder [n′] an image switching command for selecting the internal image, and, thereafter, proceeds to Step S9. On the other hand, if the recorder [n′] is not the object recorder [no], the CPU 64 sends, in Step S11, the recorder [n′] an image switching command for selecting an external image, and, thereafter, proceeds to Step S9.

In Step S9, the CPU 64 judges whether or not the currently specified recorder [n′] is the extreme end recorder at the position remotest in the same group [g] from the corresponding monitor device 80, 82 or 84, or, in other words, whether or not the recorder number [n′] is its maximum number [N′]. If it is not the extreme end recorder [N′], the CPU 64 increments the recorder number [n′] by “1” and returns to Step S5. On the other hand, if the currently specified recorder [n′] is the extreme end recorder [N′], the CPU 64 ends the recorder selecting task.

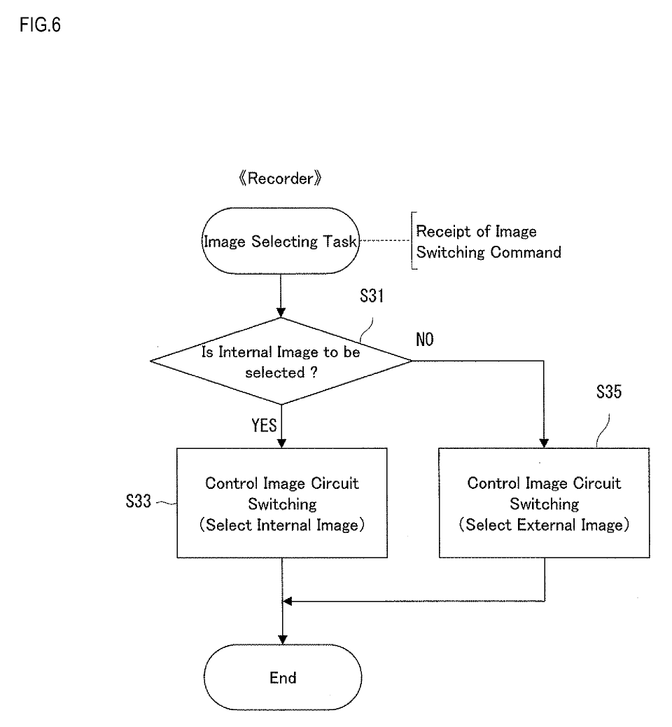

While the CPU 64 of the controller 60 operates as stated above, the CPU 32 in each recorder 20 executes the image selecting task represented by a flow chart shown in FIG. 6 in accordance with the above-described recorder control program.

On receiving the above-described image switching command from the controller 60, the CPU 32 proceeds to Step S31 where the CPU 32 judges whether the image switching command is the command to select the internal image or not. If the command is to select the internal image, the CPU 32 proceeds to Step S33, where it controls the image switching circuit 44 to cause the internal image to be selected. The execution of Step S33 completes the image selecting task shown in FIG. 6.

On the other hand, if the CPU 32 judges that the image switching command is not the command to select the internal image, i.e. if the command is to select the external image, the CPU 32 proceeds to Step S35, where it controls the image switching circuit 44 to cause the external image to be selected. This completes the image selecting task.

The recorder 20 according to the illustrated embodiment has a sequence function, too. The sequence function is a function to automatically execute, in sequence, plural, e.g. X, events as shown in FIG. 7. There are provided two types of sequence functions, one being one-time sequence function for executing one sequence of X events once, and the other being consecutive sequence function for repetitively executing this sequence. It should be noted that an event referred to herein is a processing performed by the recorder, e.g. monitoring an image taken by a particular surveillance camera 50 or changing the field of view of the surveillance camera 50 in predetermined procedures. The contents of the events can be changed as desired, and the number X of the events can be changed. The maximum number X of the events is sixteen (16), for example.

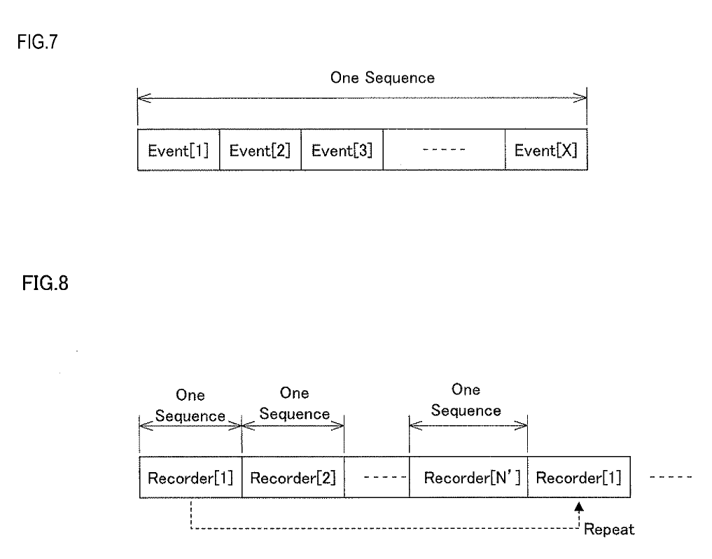

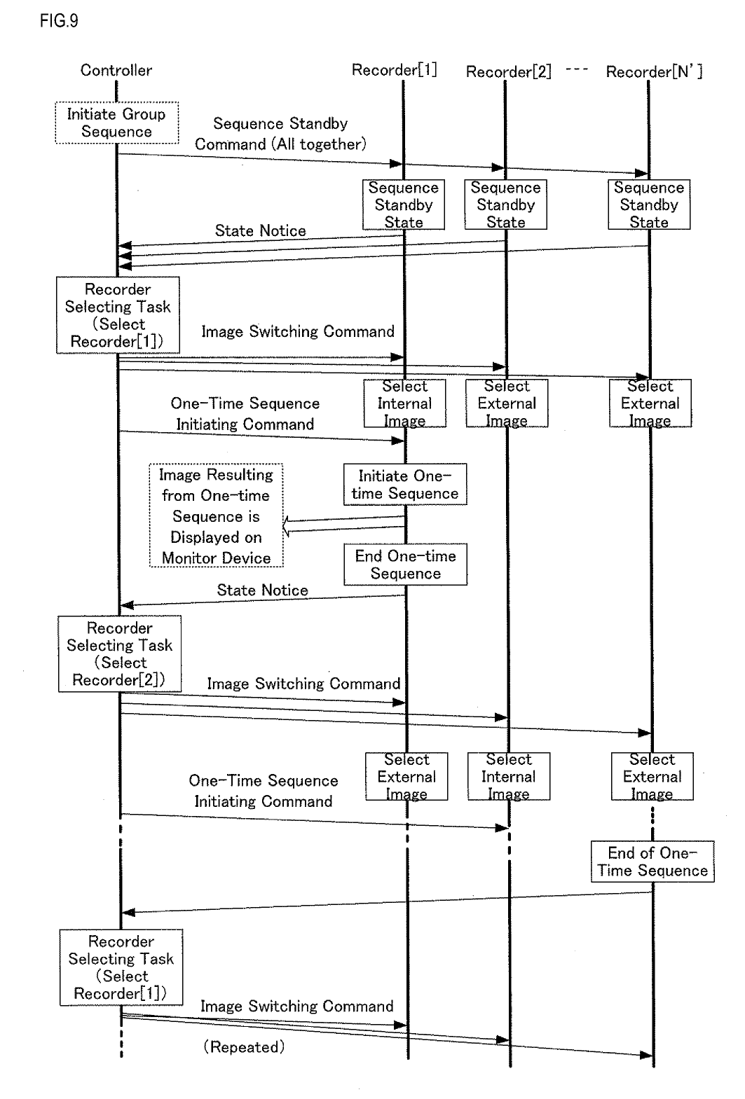

According to this embodiment, for each group [g], a group sequence function is also provided, which causes the sequence operation according to the above-described one-time sequence function to be sequentially executed for all of the recorders 20, 20, . . . , belonging to the group [g]. In other words, according to the group sequence function, for each group [g], one sequence is executed once for each of all of the recorders 20, 20, . . . , belonging to that group [g] in the order of the intra-group numbers [n′], as shown in FIG. 8, and this operation is continuously repeated.

For realizing such group sequence function, information exchange like the one shown in FIG. 9 is achieved between the controller 60 and the respective ones of the recorders 20, 20, . . . , within the group [g] subjected to the group sequence.

Specifically, when the sequence operation according to the group sequence function is initiated through the controller 60 for a desired group [g], a sequence standby command is simultaneously sent to all of the recorders 20, 20, . . . , within that desired group [g] from the controller 60. The respective recorders 20, 20, . . . , when receiving the sequence standby command, shift into a sequence standby state for awaiting the next command. After shifting into the sequence standby state, the respective recorders 20, 20, . . . , send the controller 60 a state notice that they have shifted into the sequence standby state. The sending of the state notice is done as a response to a state inquiry sent prior to it from the controller 60 to the respective recorders 20, 20, . . . .

Upon receipt of the state notice from the recorders 20, 20, . . . , the controller 60 sends the above-described image switching command to each of the record ers 20, 20, . . . . More specifically, the controller 60 sends the image switching command for selecting the internal image to the recorder 20 having the number [1] as the intra-group recorder number [n′], and the image switching command for selecting the external image to the remaining recorders 20 having intra-group numbers [2] through [N′]. Thus, only the recorder having the intra-group number [1] recorder selects the internal image, and the recorders 20 having the other intra-group numbers select the external images.

Thereafter, the controller 60 sends the recorder 20 having the intra-group number [1], which currently selects the internal image, a one-time sequence initiating command for initiating one sequence of operations, whereby the recorder 20 having the intra-group number [1] executes one sequence of operations according to the one-time sequence function. The image obtained by this one sequence of operations is displayed on the monitor device 80, 82 or 84. When this one sequence of operations is finished, a state notice indicating the finish of the one sequence of operations is sent from the recorder 20 having the intra-group number [1] to the controller 60. This state notification is done as a response to a state inquiry from the controller 60, too.

When receiving the state notice from the recorder 20 having the intra-group number [1], which notifies that one sequence of operations have been completed, the controller 60 sends the image switching commands to the recorders 20, 20, . . . , in the same group [g] including the recorder 20 having the intra-group number [2], in order to monitor the image produced as a result of the one sequence of operations of the recorder 20 having the intra-group number [2]. For example, the controller 60 sends the recorder 20 having the intra-group number [2] the image switching command for selecting the internal image, and sends the other recorders 20, 20, . . . , the image switching command for selecting the external images, whereby only the recorder 20 having the intra-group number [2] selects the internal image, whereas the remaining recorders 20, 20, . . . , select the external image. After that, processing similar to the one performed for monitoring the image produced through the one sequence of operations of the recorder 20 having the intra-group number [1] is performed. When the monitoring operation for the extreme end recorder 20 having the intra-group number [N′] is finished, the monitoring for the first recorder 20 having the intra-group number [1] is repeated. It should be noted that this sequence operation based on the group sequence function ends when other operation is initiated by the controller 60 or by the recorder 20 for which the sequence operation is being performed.

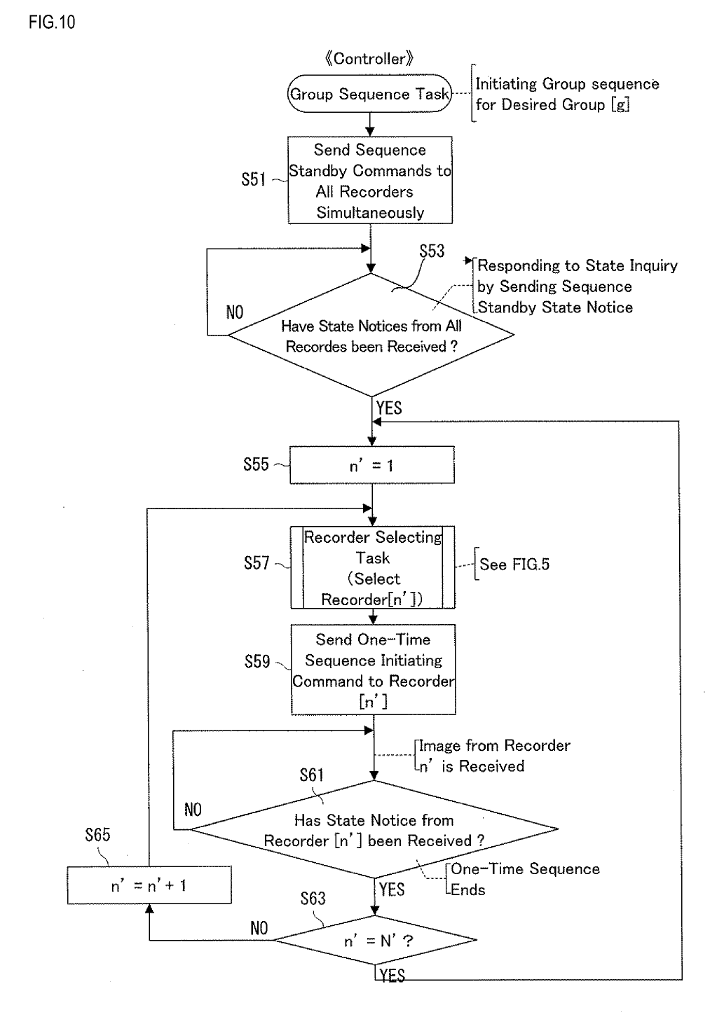

More specifically, for realizing such group sequence function, the CPU 64 within the controller 60 executes a group sequence task represented by a flow chart shown in FIG. 10, in accordance with the controller control program.

When the sequence of operations by the group sequence function is initiated for a desired group [g], the CPU 64 in the controller 60 proceeds to Step S51, where the CPU 64 sends the sequence standby command to all of the recorders 20 in that group [g], and, then, in Step S53, awaits state notices from all of the recorders 20.

Upon receipt of the state notices from all of the recorders 20 in Step S53, the CPU 64 proceeds to Step S55, and, in Step S55, employs “1” as the index [n′] for designating one of the intra-group recorder numbers [1] through [N′]. After that, the CPU 64 proceeds to Step S57, where the CPU 64 executes the above-described recorder selecting task (see FIG. 5).

After executing the recorder selecting task in Step S57, the CPU 64 proceeds to Step S59, where the CPU 64 sends a command to initiate the one-time sequence operation to the recorder 20 having the intra-group recorder number [n′]. Then, the CPU 64 proceeds to Step S61, where it awaits a state notice notifying that the one-time sequence operation has been finished, while the live image generated as a result of the one-time sequence operation of that recorder is displayed on the monitor device 80, 82 or 84 associated with that recorder.

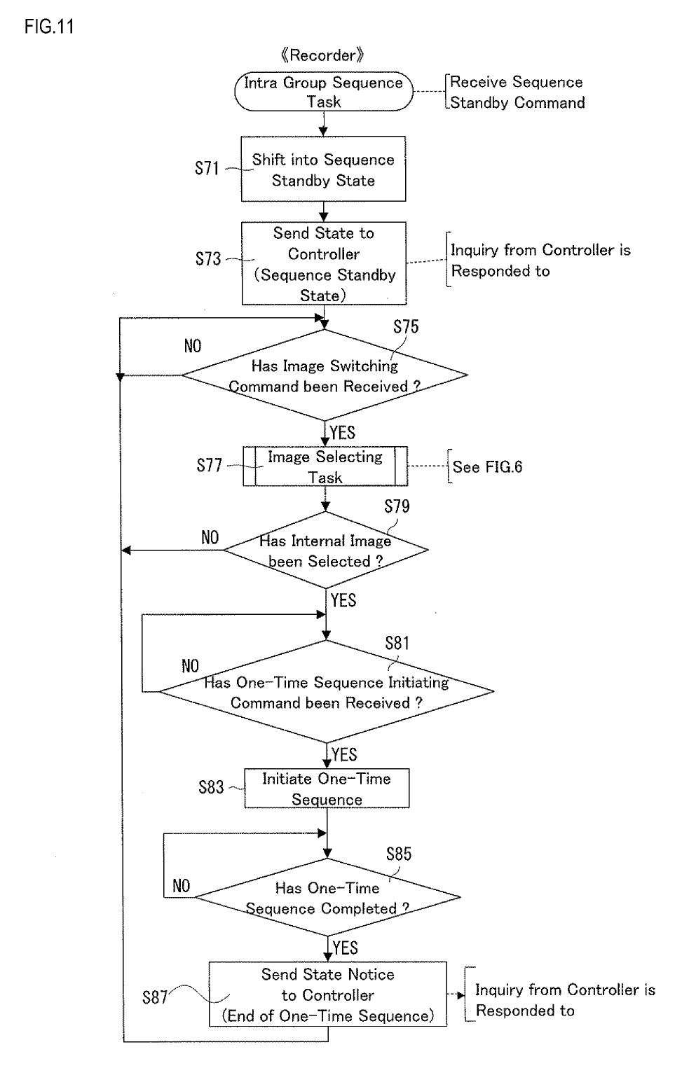

When the CPU 64 receives, in Step S61, the state notice from the recorder 20 having the intra-group recorder number [n′], the CPU 64 proceeds to Step S63, where it judges whether the current intra-group recorder number [n′] is its maximum value [N′] or not, or, in other words, whether the recorder 20 having the intra-group recorder number [n′], which has been executing the one-time sequence operation, is the recorder 20 at the extreme end having the intra-group recorder number [N′] or not. If the recorder 20 is not the extreme end recorder 20 having the intra-group recorder number [N′], the CPU 64 increments the intra-group number [n′] by “1” in Step S65 and returns to Step S55. As described above, the group sequence task shown in FIG. 10 ends whenever a different operation is demanded through the controller 60 or any recorder [n′]. In response to such operation of the controller 60, the CPU 32 of the recorder 20 executes an intra-group sequence task represented by a flow chart in FIG. 11.

Specifically, the CPU 32, when it receives the sequence standby command from the controller 60, proceeds to Step S71 and enters into the sequence standby state. Then, in Step S73, the CPU 32 notifies the controller 60 that the CPU 32 has entered into the sequence standby state, as a response to the state inquiry from the controller 60, and, after that, proceeds to Step S75, where it awaits the image switching command from the controller 60.

In Step S75, the CPU 32, upon receipt of the image switching command from the controller 60, proceeds to Step S77 to execute the previously described image selecting task (see FIG. 6). After executing the image switching task in Step S77, the CPU 32 proceeds to Step S79, where it judges whether the internal image has been selected or not in the image selecting task. If the internal image has not been selected, the CPU 32 returns to Step 75. If the internal image has been selected, the CPU 32 proceeds to the next step, Step S81.

In Step 81, the CPU 32 awaits the one-time sequence operation initiating command from the controller 60. When the CPU 32 receives that command, it proceeds to Step 83, where the one-time sequence operation is initiated, whereby the live image resulting from the one-time sequence operations is displayed on the monitor device 80, 82 or 84. In Step S85, if the one-time sequence operations are finished, the CPU 32 proceeds to Step S87, where it sends a state notice that the one-time sequence operations have been finished, as a response to the state inquiry from the controller 60. After the execution of Step S87, the CPU 32 returns to Step S75. The intra-group sequence task, too, shown in FIG. 11, ends whenever other operation is initiated through the controller 60 or through any of the recorders 20.

As described above, by the use of the group sequence function according to this embodiment, one-time sequences set for individual recorders 20 of each group [g] are successively executed, mutually being synchronized (or timed) with the other ones of the recorders 20 in that group. Accordingly, it is as if a series of sequential operations were executed for each of the groups [g], which makes it possible to achieve proper surveillance for particular situations.

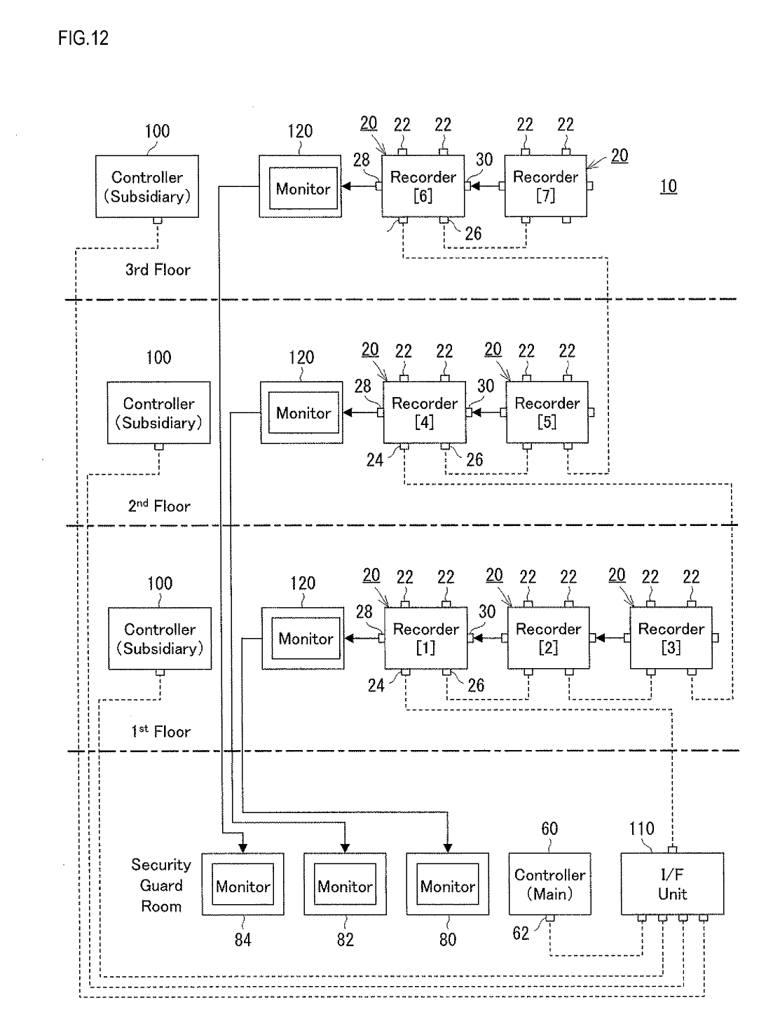

According to the described embodiment, only one controller 60 is used as a main controller, but the invention is not limited to it. For example, as shown in FIG. 12, subsidiary controllers 100 may be used, each being dedicated for one group [g], so that the recorders 20, 20, . . . , of each group [g] can be controlled by that subsidiary controller 100. In this case, an interface (I/F) unit 110 is required for interconnecting the respective controllers 60, 100, 100, . . . , and the respective recorders 20, 20, . . . . Furthermore, monitors 120, separate from the above-described ones, may be disposed on the respective floors.

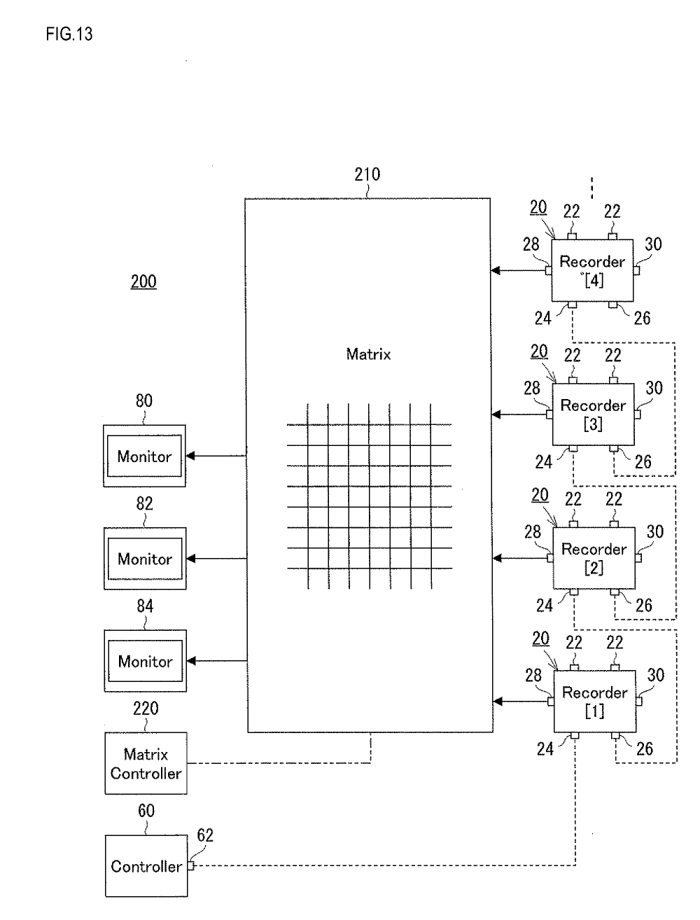

Further, like a surveillance system shown in FIG. 13, for example, a matrix device 210 may be used, as input/output altering means of which the input and output connections can be altered, with the image output terminals 28 of the respective recorders 20, 20, . . . , connected to the input side of the matrix device 210, and with the monitor devices 80, 82 and 84 connected to the output side of the matrix device 210. With this arrangement, various situations can be coped with flexibly and properly by the control through the controller 60 and the control through a control apparatus 220 for the matrix device 210. The controller 60 and the control apparatus 220 may be integrated together into a single apparatus to integrate the controls of the recorders 20, 20, . . . and the control of the matrix device 210.

Further, although not shown, another, second image output terminal may be provided for each recorder 20. With this arrangement, images different from the ones displayed on the monitor devices 80, 82 and 84 can be monitored by the use of the second image output terminal.

Although the invention has been described by means of embodiments in which seven recorders 20 are used, being divided into three groups [g], but the number of the recorders 20 in the respective groups [g] and the number of the groups [g] are not limited to the described ones. Further, the recorders 20 may include a record medium different from the hard disc 42.

The invention has been described, being applied for surveillance of three-storied building, but the invention can be used for surveillance for different purposes. The content of the above description of the embodiments is only an example useful for realizing the present invention and does not limit the scope of the invention.

1. (canceled)

2. (canceled)

3. (canceled)

4. (canceled)

5. (canceled)

6. A surveillance system comprising:
a plurality of groups each comprising a plurality of video devices connected in series with one display device with said display device being the forefront of said series connection, a plurality of cameras being connected to each of said video devices, each of said video devices being so arranged to be switchable between an internal connection state in which an image signal from a selected one of said cameras connected to said video device is outputted to a preceding stage, and an external connection state in which an image signal from a succeeding video device is coupled to a preceding stage; and
one controller for controlling each of said video device in each of said groups;
different group identification codes being assigned to respective ones of said groups, serial intra-group camera codes being assigned to said cameras of each of said groups, different video device identification codes being assigned to said respective video devices of each of said groups;
said controller including a table in which correlation between said intra-group camera identification codes and said video device identification codes are stored for respective ones of said groups;
when one of said group identification codes and one of said intra-group camera identification codes are supplied, said controller referring to said table for selecting a camera corresponding to said supplied intra-group camera identification code in said supplied group identification code and placing in the internal connection state, a video device having a video device identification code related to said supplied intra-group camera identification code, and placing remaining ones of said video devices in the same group in the external connection state.

7. The surveillance system according to claim 6, wherein said cameras are assigned with camera identification codes for each of said video devices to which said cameras are connected; said table also has stored therein correlation between said respective intra-group identification codes and said camera identification codes; and said controller, when supplied with said one group identification code and said one intra-group identification code, selects a camera having the camera identification code correlated to said intra-group identification code.
